(19) United States
(12) Patent Application Publication
(10) Pub. No.: US 2001/0049614 A1
(43) Pub. Date: Dec. 6, 2001

(54) Business to business bundle

(76) Inventor: Roger Hoffman, Green Bay, WI (US)

Correspondence Address: WEISS & WEISS PC, Suite 305, 500 Old Country Road, Garden City, NY, 11530, US

(21) Appl. No.: 09/870,199

(22) Filed: May 29, 2001

Related U.S. Application Data
(60) Provisional application No. 60/208,369, filed on May 30, 2000.

(51) Int. Cl. G06F 17/60

(52) U.S. Cl. 705/7; 705/8; 705/26

(57) ABSTRACT

The present invention relates to a method and system for bundling orders of customers so as to make a business operation more efficient.

### FIELD OF THE INVENTION

The present invention relates to a method and system for bundling orders of customers so as to make a business operation more efficient.

### BACKGROUND OF THE INVENTION

Most companies who are in the field of producing products produce several different products on the same machine. It cost the company time and money to continue switching from producing one product to producing a second and then a third product. Each time a company has to switch to producing a different product there is downtime associated with changing the specifications and characteristics of a second different product.

For instance, in the paper industry a paper machine can produce many different grades of paper. It can produce 18 pound paper to a 120 pound paper on the same machine each grade of paper having different characteristics. There would be great savings associated with having a machine produce the same grade of paper or a paper having similar characteristics for a continuous amount of time prior to switching to a different grade of paper or paper having different characteristics.

If a company knew ahead of time that it was going to be producing a specific product for a greater amount of time, it could give its customers a lower price for those products since it would cost the company less money to produce those goods.

Presently a company receives orders from different customers, and usually based on when those orders are received operates their machinery to produce products in response to those orders. Some companies try to organize their production based on the most cost efficient way of producing the products and then organizing their orders. Presently, there is no system that actively tries to provide information on when a company is producing a certain product with specific specifications, and that if a customer were to place an order for this product or a similar product at this time it could be bundled with other orders for this product or a similar product and produced at a lower price to the customer.

### SUMMARY OF THE INVENTION

The present invention relates to a system and method for bundling orders for the same product or a similar product to increase cost savings to both the manufacturer and the customer.

The present invention relates to a system for bundling orders. It is an object of the present invention to calculate in real time the cost savings to the manufacturer for bundling the orders. It is an object of the present invention to determine based on the similarity of the orders which of the orders to bundle which would create the greatest cost savings. The closer the specifications are between similar products, the greater the cost savings are to the manufacturer, the lower the cost can be to the customer. It is an object of the present invention to calculate the price of the new orders based on bundling.

The present invention relates to a method for bundling orders for same product or a similar product comprising; inputting into a computer database a product schedule, and new orders for products. The system then matches the new orders with the product schedule. It is an object of the present invention to compare the new ordered product to the scheduled product. It is a further object of the present invention to provide a method which reschedules the production of products on the product schedule.

It is an object of the present invention to provide a system and method whereby a manufacturer can provide a schedule of when a certain product will be produced. It is a further object of the present invention to provide a system and method for matching orders placed by customers having a specific delivery date associated with the order, to manufactures who are producing those specific products or similar products at or around the time that the customer request those products to be produced. The closer the specifications are between similar products, the greater the cost savings are to the manufacturer, the lower the cost is to the customer. Similar products can be products that are produced using similar equipment or are products that have similar characteristics.

It is an object of the present invention to provide a system and method whereby different customers can place orders for the same product or similar product having the same or similar specifications. These orders are then placed together with the same manufacturer to be produced continuously at the same time whereby both the manufacturer and the customer can achieve cost savings.

### DETAILED DESCRIPTION OF THE INVENTION

An example of the present invention is as follows:

Manufacturer A has the following production schedule:

September, Product 1; October, Product 2; November, Product 3; and December, Product 4.

The following customers require the following products at the following times:

Customer A September, Product 1 October, Product 3; November, Product 2; December, Product 4.

Customer B September, Product 2; October, Product 2; November, Product 3; December Product 4.

Customer C September, Product 3 October, Product 2; November, Product 4 December, Product 1.

Each of the above information is inputted into the system of the present invention. Based on the inputted information, the system of the present invention assists both the customer and the manufacturer so that the manufacturer can produce product 1 in September for Customer A, product 2 in October 2 for Customers B and C, product 3 in November for Customer B and Product 4 in December for Customers A and B.

The system of the present invention will also advertise the reduced price of the product based on bundling of the orders. Therefore customers who are advertising that they could receive certain goods on certain dates may change their orders based on the reduced price that the manufacturer can charge based on the bundling of orders.

For example, if the products above are for the paper industry, bundling could take place if the products are the same or the products have similar characteristics. Similar characteristics for the paper industry include: basis weight, calendaring, wet strength, color, and type of pulp used.

What is claimed is:

1. A system for bundling orders comprising;
a database;
said database comprising information relating to a production schedule and new ordered products;
said system compares said new ordered product to said scheduled products and determines whether said new orders and said scheduled products can be bundled.

2. The system of claim 1 wherein said production schedule is reordered after bundling said new orders.

3. The system of claim 1 wherein said system calculates price of said new orders based on bundling.

4. The system of claim 1 wherein said system calculates in real time cost savings bundling said orders.

5. The system of claim 1 wherein said system determines bundling of said orders based on greatest cost savings.

6. A method for bundling orders for same product or a similar product comprising;
inputting into a computer database a product schedule;
inputting into said computer database new orders for products;
matching said new orders with said product schedule.

7. The method of claim 6 further comprising;
rescheduling said product schedule.

8. The method of claim 6 further comprising;
calculating price of said new order based on the savings of bundling said new orders to said scheduled product.

9. The method of claim 6 further comprising;
calculating in real time cost savings of bundling said orders.

10. The method of claim 6 further comprising
bundling said orders based on greatest cost savings.
